(19) United States
(12) Patent Application Publication
(10) Pub. No.: US 2014/0347553 A1
(43) Pub. Date: Nov. 27, 2014

(54) IMAGING DEVICES WITH LIGHT SOURCES FOR REDUCED SHADOW, CONTROLLERS AND METHODS

(71) Applicant: Samsung Electronics Co., Ltd., Suwon-si (KR)

(72) Inventors: Ilia OVSIANNIKOV, Studio City, CA (US); Dong-Ki MIN, Seoul (KR)

(73) Assignee: Samsung Electronics Co., Ltd., Suwon-si (KR)

(21) Appl. No.: 13/902,752

(22) Filed: May 24, 2013

(51) Int. Cl. H04N 5/225; G03B 9/08

(52) U.S. Cl. CPC H04N 5/2256; G03B 9/08
USPC 348/367; 348/370

(57) ABSTRACT

An imaging device includes a casing, a defined a field of view, and light sources on the casing. Each light source has a field of illumination configured to illuminate a respective distinct sector of the FOV at a higher intensity than the other sectors. Accordingly, any partial shadow or visible partial shadow around a front image can be reduced or eliminated completely.

### BACKGROUND

Imaging devices, such as cameras, often use a light source, such as a flashlight, to illuminate their field of view. The object in the field of view receives the additional illumination, and reflects it back in the camera. The received reflection enables the imaging device with both functions of rendering an improved image of the object, and in more accurately determining the object's distance from the camera, which is also called range-finding.

Multiple such light sources are sometimes used to increase the overall amount of illumination power. Sources used these days include light emitting diodes and laser diodes. The use of multiple such light sources, however, sometimes creates problems, both in the imaging function and in the range-finding function. A number of these problems are now described.

FIG. 1A is a composite diagram that illustrates an imaging scenario. An imaging device 100 of the prior art, such as a camera, is shown in a plan view. Imaging device 100 has a casing 110, and includes an opening OP in casing 110. Device 100 also has a pixel array PA for receiving light through opening OP. Imaging device 100 has a defined field of view (“FOV”) 104, which starts with opening OP and is bounded by rays also designated 104. Of course, the FOV is in three dimensions, while rays 104 are in the plane of the two-dimensional diagram.

Imaging device 100 also includes two light sources PLS. Each light source PLS has a Field Of Illumination (“FOI”) 106, each shown by boundary rays 106. FOIs 106 generally illuminate FOV 104, and thus also whatever is placed in it.

In the scenario of FIG. 1A, imaging device 100 has been placed such that a front object FO, against a background object BO, are within FOV 104. For example, a person's face could be imaged against a wall. FOIs 106 illuminate front object FO against background object BO. Ray analysis can be used to detect shadows against background object BO. A full shadow area FS is behind front object FO, which is an area not reached by the light from either light source PLS. Adjacent full shadow area FS there are areas of partial shadows PS, since these are reached by only one of light sources PLS. Within areas PS, there are thinner areas VPS of virtual partial shadows. Areas VPS are the portions of areas PS that imaging device can image. Finally, beyond areas PS, there are areas of no shadow NS.

FIG. 1A also illustrates a one-dimensional representation 174 of the resulting image, as seen by imaging device 100. Front object FO will generate image <FO> and background object BO will generate image <BO> rather accurately, because neither has a shadow on it. However, areas VPS of virtual partial shadow will be darker than either of its neighboring areas, because they receive illumination from only one sight source PLS, not two. As such, areas VPS will appear as thin areas of shadows around edges of image <FO> of the front object, and thus degrade the image.

The above problem with imaging also degrades range-finding. Before explaining how, range-finding itself is now explained.

Pixel array PA is used for both imaging and detecting distance. Pixel array PA has M columns by N rows of pixels. Each pixel acts as an individual distance detector, and captures data samples.

Either one of light sources PLS emits a periodic waveform that travels to Front Object FO, reflects from it, and travels back to the imaging sensor in pixel array PA. When the time-of-flight (“TOF”) principle is used, the imaging sensor compares the phase of the outgoing light waveform to the phase of the returning light waveform, and estimates a phase difference Δφ which, in turn, indicates the distance between the camera and the object.

The signal corresponding to the outgoing light waveform and its phase is called demodulation clock. The demodulation clock is supplied to all pixels in the sensor, so as to enable the abovementioned comparison.

A typical TOF camera calculates phase φ by taking 4 samples of image intensity per light waveform period. These samples are designated as A₀, A₁, A₂, A₃. An example of taking these samples is now described.

A range-finding device can be equipped with various types of shutters; the two most common ones are freeze-frame shutter and rolling shutter. A rolling shutter operates by staggering exposure of rows of pixels. Additional explanation is provided in US Patent Application No. 20120062705, which is hereby incorporated by reference.

FIG. 1B is a diagram illustrating a rolling shutter operation during a range-finding mode. Four measurements are taken in a batch, one for each of A₀, A₁, A₂, A₃. Two such batches are shown. For each batch, light sources PLS are continuously enabled when raw frames are continuously captured, without interruptions. One range-finding camera operation mode requires the imager to repeat exposing a number of raw frames, followed by a certain idle time duration—an operation sometimes referred to as burst. It is the burst operation that is shown in FIG. 1B. The one or more light sources are enabled as soon as the exposure of the first image row starts at t_{0,RS,k}. When all four entire frames have been exposed and read out, the light source output can be disabled for power reduction purposes at time t_{N,RD,k+3}. This process repeats for the next batch of frames to be exposed and captured.

Due to the row exposure being staggered, some of the light source power is wasted at the start and end of each batch. Specifically, between times t_{0,RS,k} and t_{N,RS,k}, the light sources illuminates the entire scene, but reflected light impinging on rows that have not yet been reset serves no valuable purpose. Similarly, the light source must remain enabled until the last row has been read out at time t_{N,RD,k+3}. Between times t_{0,RD,k+3} and t_{N,RD,k+3}, reflected light impinging rows that have already been read out also serves no purpose.

FIG. 1C shows equations 1-5 for what data to calculate from the measurement of FIG. 1B. In those equations, B is the offset corresponding to background illumination, A is the AC amplitude of the returning modulated light waveform, d is the measured distance, f_{MOD} is the modulation/demodulation frequency, c is the speed of light, D_{AMBIG} is the ambiguity range, and k is a non-negative integer. The measured distance to object D_{i,j} corresponding to pixel {i,j} can differ from the actual distance by the camera's ambiguity range D_{AMBIG}, or a natural multiple of it.

FIG. 1D is a sequence of diagrams, starting with one-dimensional representation 174 of the resulting image of FIG. 1A. This time representation 174 is shown along a horizontal dimension, and salient points have been moved horizontally to illustrate the problem.

Another diagram 184 is in sequence with one-dimensional representation 174, and shows a sequence of pixels of pixel array PA. In the vertical axis, diagram 184 shows the AC illumination provided by light sources PLS to these pixels. Image <FO> will receive the most light, being illuminated by both light sources PLS, plus being the closest. A problem in the prior art is, therefore, that the pixels at the center of the array become saturated more often. In the absence of ambient illumination, pixels that would image area VPS would have half the level of AC amplitude as those that image background object BO. It should be remembered that diagram 184 arises from ray optics.

One more diagram 194 is in sequence with diagram 184, and shows the same pixels. In the vertical axis, diagram 194 shows a representation of the distance detected from the image, while in range-finding mode. Strictly speaking, the representation is actually an inverse of the detected distance, as image <FO> is closer to imaging device 100 than the other images <VPS> and <BO>. This does not matter, however; what matters is that, while the detected distances are uniform for images <FO> and <BO>, for the spaces in between the distances appear “smeared”, and correspond to spaces where there can be error in computing distance.

More particularly, the AC signal corresponding to the background object is expected to be low due to the background object being further away than the foreground object plus due to the VPS shadow. In addition, the AC signal corresponding to the foreground object is expected to be high due to the foreground object being closer than the background object, plus due to the absence of shadow. Pixels imaging the background object in the areas immediately adjacent to the foreground object will detect AC signal from two sources, namely AC signal from the background object itself, plus AC signal from the immediately adjacent foreground object. The latter unwanted AC signal can be caused by lens blur and smear due to various internal optical reflections and imperfections in the camera and electrical imperfections of the sensor. Both desired and undesired AC components will be sensed as sum of vectors by the pixel, thus causing accuracy degradation of measured distance, potentially making the pixel reading erroneous and potentially unusable, thus ultimately degrading camera's spatial resolution. Since AC signal received from the foreground object is strong compared to AC signal received from the background object, even low degrees of blur and smear in the camera can cause the foreground AC signal to overpower the background AC signal, making pixel output unusable.

Range finding is also impacted by other sources of error. One such source is from the fact that the light sources are not collocated with the opening, even though they are placed close. When the front object is off axis, the distance between each source PLS and the object is not the same, thus permitting error in the measured distance. One more source of error is now described.

FIG. 2 is a diagram showing how range finding by the imaging device of FIG. 1A can be subject to error due to reflections from a side object. In FIG. 2, some of the same components are shown as in the imaging scenario of FIG. 1A. Moreover, a side object SO is added. Ordinarily, range finding is by transmitting light from one of light sources PLS, and have it be reflected from front object FO to pixel array PA through opening OP, for example traveling along rays 218. However, side object SO permits light from the same source to also enter pixel array PA by traveling along rays 219. Here, multi-path illumination thus interferes with the regular illumination; at each pixel, electric fields are added by vector addition, causing error.

The presence of erroneous measurements can result in far-away objects appearing very close, thus likely preventing the application that is using range images from functioning correctly.

### BRIEF SUMMARY

The present description gives instances of imaging devices, systems, controllers and methods, the use of which may help overcome problems and limitations of the prior art.

In one embodiment, an imaging device includes a casing and a defined field of view, and light sources on the casing. Each light source has a field of illumination configured to illuminate a respective distinct sector of the FOV at a higher intensity than the other sectors.

Accordingly, any partial shadow or visible partial shadow can be reduced or eliminated completely, which both improves the image and reduces errors in range-finding. Moreover, range-finding is subject to fewer possible side reflections, and therefore subject to less error. As such embodiments of the invention remove errors in range-finding by preventing them from happening in the first place.

Additionally, the center portion of the imaged object does not become over-illuminated, and therefore pixels at the center of an imaging array have less chance of becoming saturated. Moreover, if implemented with rolling shutter operation, each light source will need to be turned on for a lesser time than otherwise, thus saving power. Further, embodiments are economical to implement, and increasingly important for 3D sensors, as resolution increases.

These and other features and advantages of this description will become more readily apparent from the following Detailed Description, which proceeds with reference to the drawings, in which:

### BRIEF DESCRIPTION OF THE DRAWINGS

FIG. 1A is a composite diagram illustrating an imaging scenario in the prior art, along with a one-dimensional representation of the resulting image, for explaining imaging problems in the prior art.

FIG. 1B is a timing diagram illustrating a rolling shutter operation during a range-finding mode for taking measurements.

FIG. 1C shows equations for determining distance from the measurements of FIG. 1B.

FIG. 1D is a sequence of diagrams that illustrate how the imaging problems in the prior art of in FIG. 1A also introduce error in range-finding.

FIG. 2 is a diagram showing another range-finding scenario for the imaging device of FIG. 1A, which can be subject to error due to reflections from a side object.

FIG. 3 is a block diagram of an imaging device made according to embodiments.

FIG. 4 is a composite diagram illustrating an imaging scenario of the device of FIG. 3, along with a one-dimensional representation of the resulting image.

FIG. 5 is a sequence of diagrams that illustrate range-finding aspects for the device of FIG. 3.

FIG. 6 is a diagram showing another range-finding scenario for the device of FIG. 3.

FIG. 7 is a timing diagram illustrating a rolling shutter operation during a range-finding mode for the device of FIG. 3.

FIG. 8A is a diagram of a front view of an imaging device with four light sources according to an embodiment.

FIG. 8B is a diagram of a first set of sectors for possible fields of illumination resulting from the imaging device of FIG. 8A.

FIG. 8C is a diagram of a second set of sectors for possible fields of illumination resulting from the imaging device of FIG. 8A.

FIG. 9 is a flowchart for illustrating methods according to embodiments.

FIG. 10 depicts a controller-based system for an imaging device that can be made according to embodiments.

### DETAILED DESCRIPTION

As has been mentioned, the present description is about imaging devices, systems, controllers and methods. Embodiments are now described in more detail.

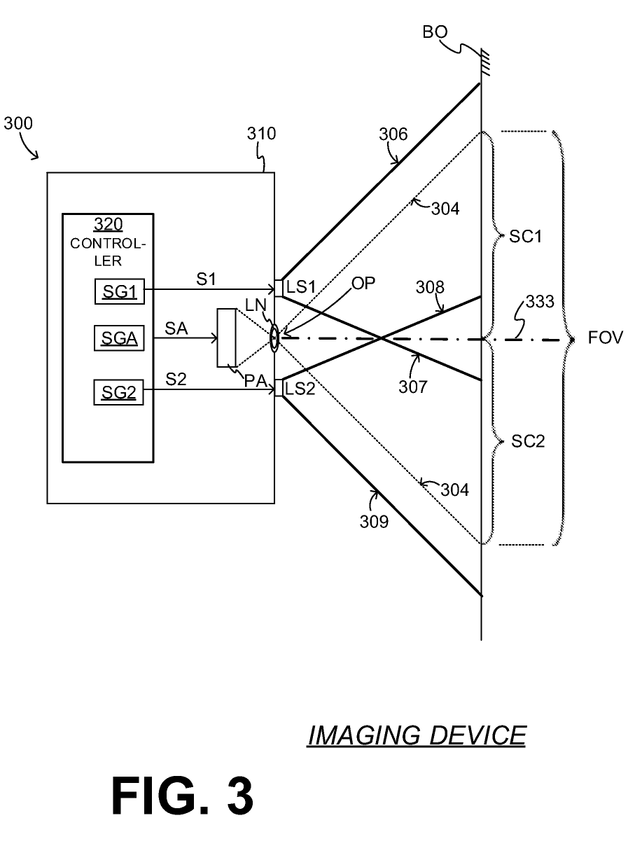

FIG. 3 is a block diagram of an imaging device 100 made according to embodiments. Imaging device 300 has a casing 310, and includes an opening OP in casing 310. An optional lens LN is provided at opening OP, although that is not necessary.

Device 300 also has a pixel array PA for receiving light through opening OP. Pixel array PA has rows and columns of pixels. Device 300 additionally includes a controller 320, for controlling the operation of pixel array PA and other components. Controller 320 is described in more detail later in this document. Imaging device 300 has a defined field of view (“FOV”) 304, which starts with opening OP and is bounded by rays also designated 304. Of course, the FOV is in three dimensions, while rays 304 are in the plane of the two-dimensional diagram.

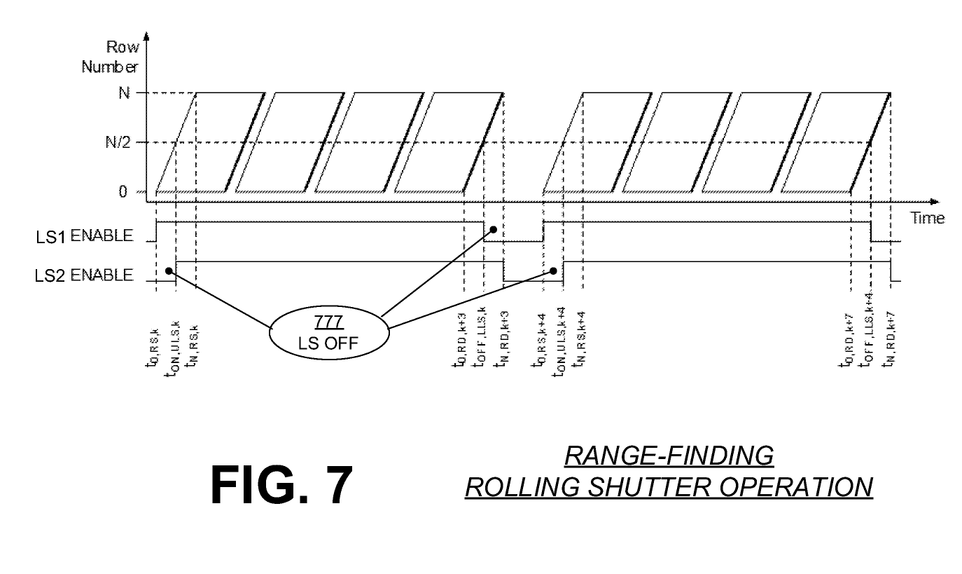

Imaging device 300 also includes two light sources LS1 and LS2, both controlled by controller 320. Light sources LS1 and LS2 can be arranged either to the right and the left of opening OP, or above and below, and so on. It will become apparent later in this document that either choice may, in some embodiments, have to be coordinated with a choice of orientation for pixel array PA within casing 310, so as to further achieve the effect of FIG. 7. In many embodiments, light sources LS1 and LS2 emit modulated light when enabled as per the above, and no light when disabled.

For purposes of describing optical patterns, imaging device 300 is shown against background object BO. Light source LS1 has a FOI that starts from LS1, and is bounded by rays 306, 307. Light source LS2 has a FOI that starts from LS2, and is bounded by rays 308, 309. These FOIs generally illuminate different sectors SC1, SC2 of FOV 304, although there may be a small overlap at the boundaries. A boundary of where they may overlap can be at the center of FOV 104. The overlap may occur because it is very difficult to contain precisely light where light goes, especially light of high brightness.

In other words, FOV 304 is considered divided into two sectors, as there are two light sources LS1, LS2. Division can be by a mid-plane 333 that dissects FOV 304 into sectors SC1, SC2. Light source LS1 is configured to illuminate sector SC1 at a first intensity, defined as light energy per time. Plus, light source LS1 is configured to illuminate a lot less, or not at all, any place outside sector SC1. For example, light source LS1 might illuminate sector SC2 at 50%, 20%, 5% or even less of the first intensity. For another example, light source LS1 might illuminate sector SC1 with more than twice, five, or ten times the intensity that it illuminates sector SC2. As such, light source LS1 might not illuminate substantial portions of FOV 304.

It will be observed that the FOIs of light sources LS1, LS2 do not generally “point” in parallel forward directions, as does FOV 104. Rather, their general directions diverge from each other. In embodiments where the FOIs are exactly conical, the centerlines of the cones diverge. The directionality of the FOIs of light sources LS1, LS2 according to the invention can be accomplished in any number of ways, such by having light sources LS1, LS2 use one or more mirrors, lens systems, holographic optical filters, specially shaped lamps, and so on.

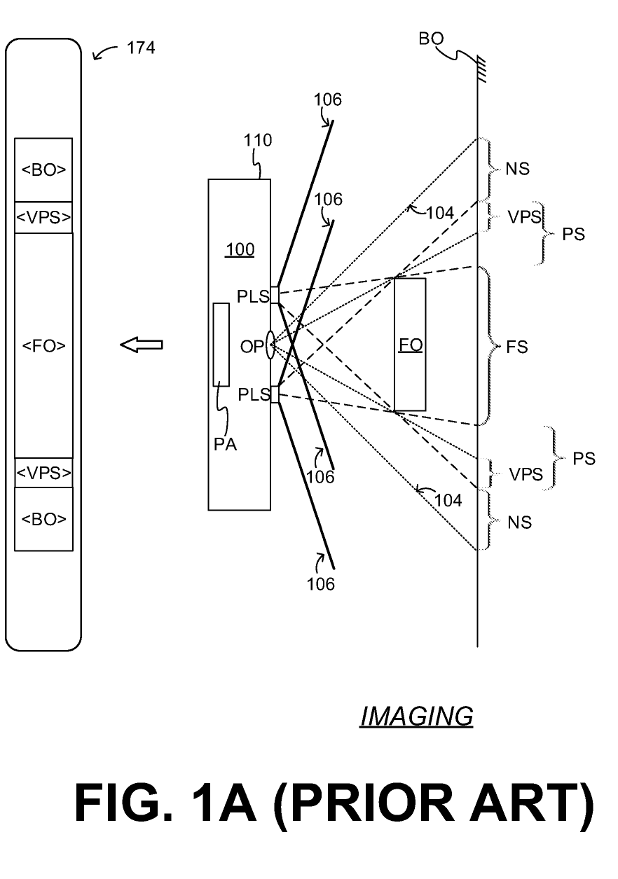

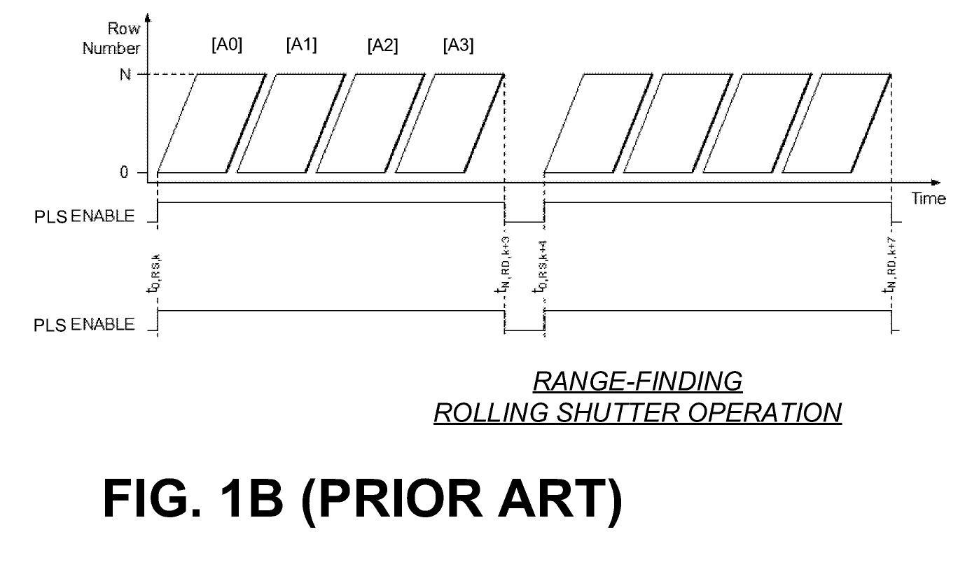

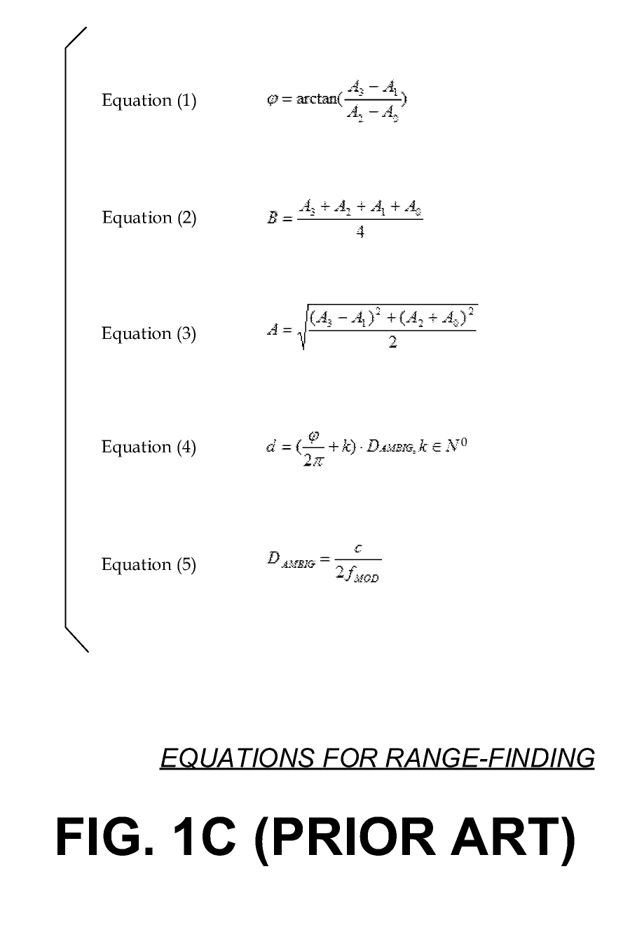

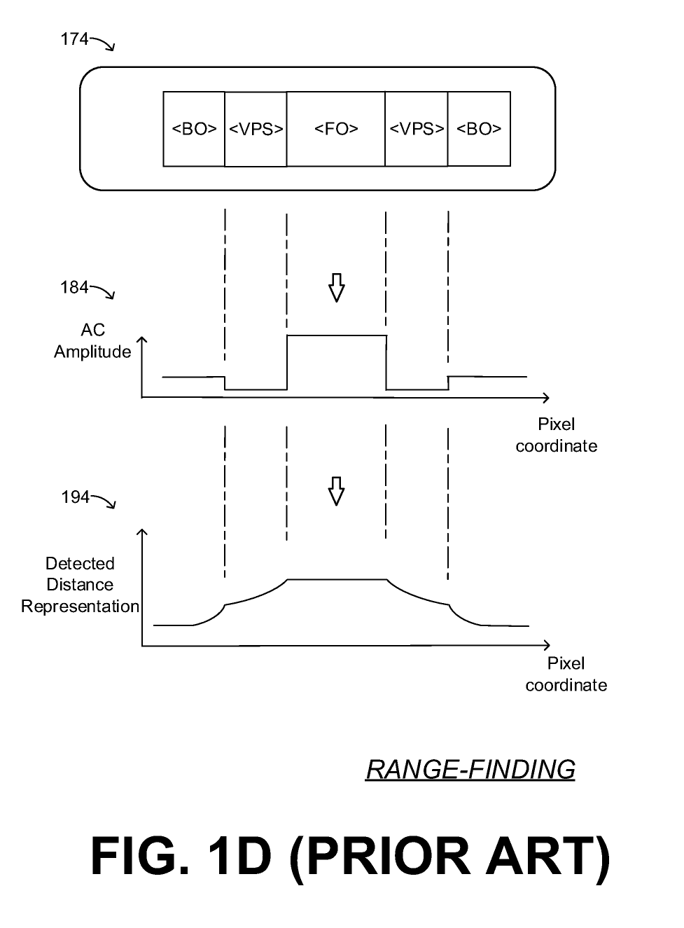

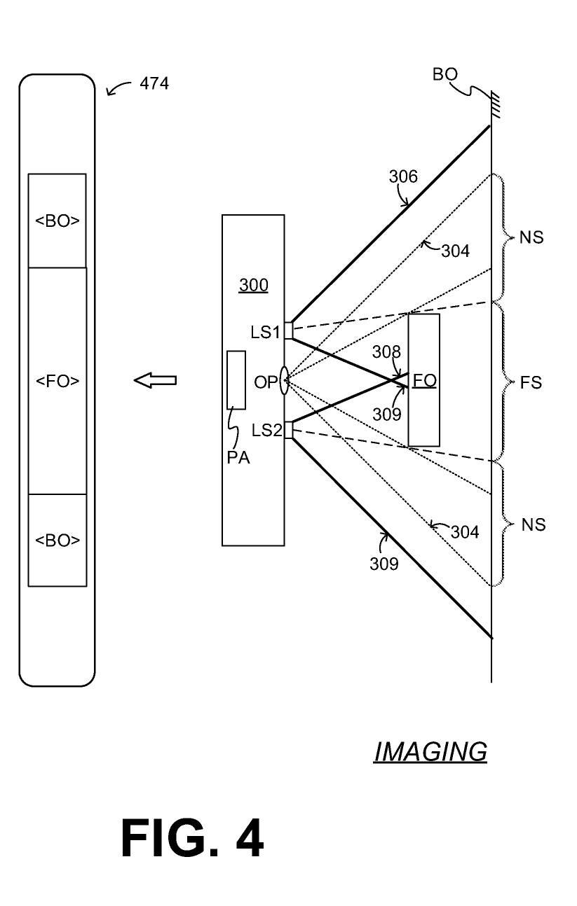

FIG. 4 is a composite diagram that illustrates an imaging scenario for imaging device 300 of FIG. 3. Imaging device 300 has been placed such that a front object FO, against a background object BO, are within FOV 304. The FOIs from light sources LS1, LS2 illuminate front object FO against background object BO. A full shadow area FS is behind front object FO, which is an area not reached by the light from either light source LS1 or LS2. Adjacent full shadow area FS there are areas of no shadow NS. It will be observed that, in this scenario, there are no partial shadow areas, as there were in FIG. 1A. This was enabled by the directionality of the FOIs of light sources LS1, LS2. More particularly, from light source LS1, ray 309 does not go past front object FO. And, from light source LS2, ray 308 does not go past front object FO. It will be further observed that, in this scenario, areas NS of no shadow are illuminated by a single one of light sources LS1, LS2.

FIG. 4 also illustrates a one-dimensional representation 474 of the resulting image, as seen by imaging device 400. Front object FO will generate image <FO>, and background object BO will generate image <BO> rather accurately, because neither has a shadow on it. There are no areas of virtual partial shadows on background object BO; as such there will be no thin areas of shadows around edges of image <FO> of the front object in representation 474, which therefore results in an improved image.

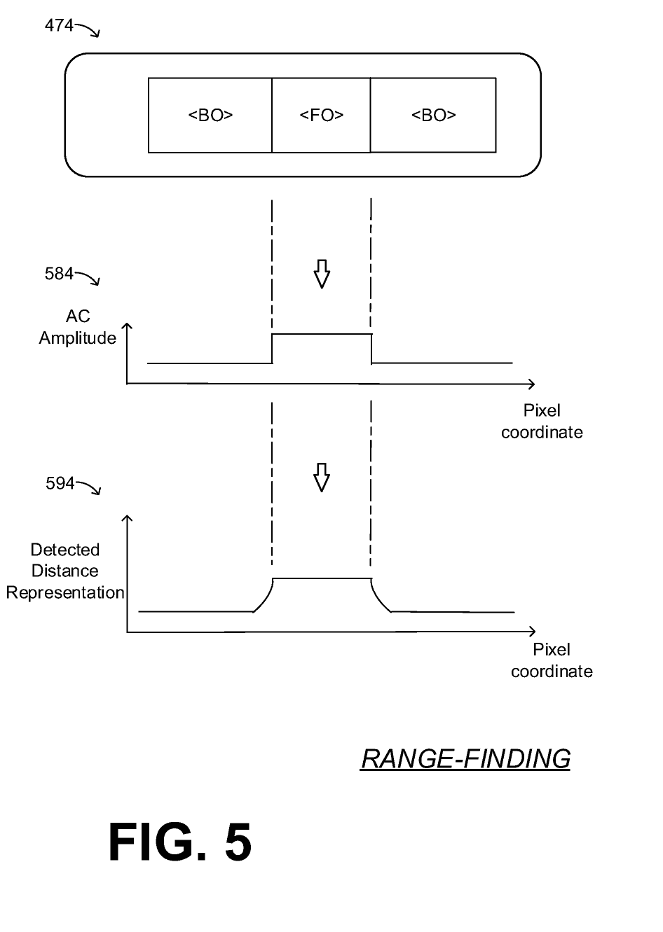

FIG. 5 is a sequence of diagrams that illustrate range-finding aspects for the device of FIG. 3. One-dimensional representation 474 of FIG. 4 is shown along a horizontal dimension, and salient points have been moved horizontally to illustrate the desired aspects.

Another diagram 584 is in sequence with one-dimensional representation 474, and shows a sequence of pixels of pixel array PA. In the vertical axis, diagram 584 shows the AC illumination provided by light sources PLS to these pixels. Image <FO> will receive the most light, being illuminated by both light sources PLS, plus being the closest. Still it will be less light than in FIG. 1D, because the FOIs of light sources LS1, LS2 diverge. As such, the center pixels will be less prone to saturation. Image <BO> will receive less light. Contrasted with FIG. 1D, it will be appreciated that there are no areas equivalent to areas VPS of FIG. 1A.

One more diagram 594 is in sequence with diagram 584, and shows the same pixels. In the vertical axis, diagram 594 shows a representation of the distance detected from the image, while in range-finding mode. Strictly speaking, as with FIG. 1D, the representation is actually an inverse of the detected distance. This does not matter, however; what matters is that, because there are no VPS areas, the transition from one level of values to the other is a lot less “smeared”, than in FIG. 1D.

Range finding is improved when embodiments are used. A source of error in the prior art was from when an object was off-axis, and therefore its distance from the light sources was not the same. This problem is removed for when the object, or one of its points, is illuminated by one of the diverging light sources but not the other.

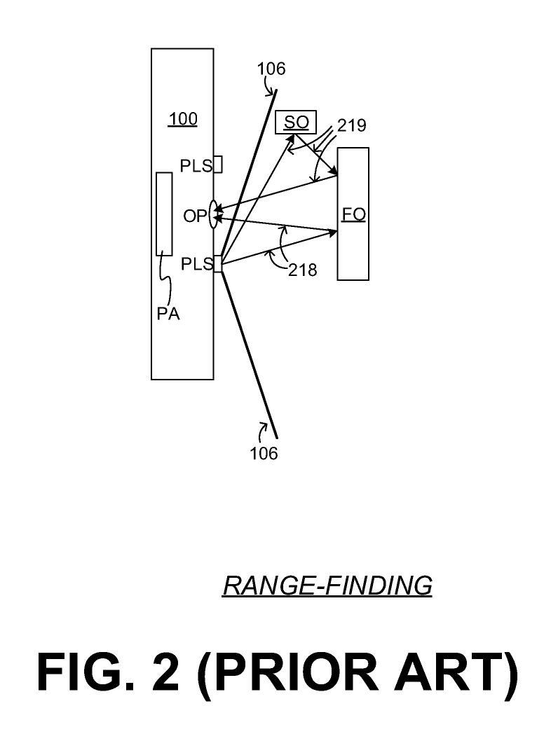

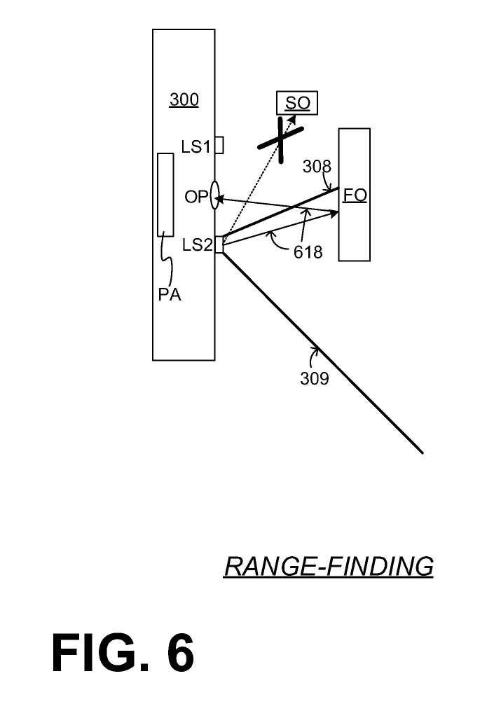

FIG. 6 is a diagram showing another range-finding scenario for the device of FIG. 3. Detecting the distance can take place similarly to what was described above for FIG. 2, with light traveling from light source LS2 via rays 618. While side object SO is provided, it is not illuminated by light source LS2 by its design; indeed ray 308 does not reach that far. As such, there is no multi-path illumination to interfere with the regular illumination of rays 618. Of course, side object SO can still be a problem with light source LS1 but still this embodiment has removed one source of error.

Embodiments of the invention provide one more advantage. Light sources LS1, LS2 can be enabled on and off in synchronization with a timing of the rolling shutter, to conserve power. An example is described.

FIG. 7 is a timing diagram illustrating a rolling shutter operation during a range-finding mode for the device of FIG. 3. It will be appreciated that the operation is the same as in FIG. 1B, except that light sources LS1, LS2 need not be on all the time. Comment 777 points to time durations in FIG. 7 when one of light sources LS1, LS2 can be off, according to its LS ENABLE signal.

For example assume that light source LS1 illuminates one half of the FOV imaged by sensor rows from 0 to N/2, and further that light source LS2 illuminates the other half, which is imaged by sensor rows from N/2+1 to N. Referring to FIG. 7, when capture starts after idle time, light source LS1 is enabled at the same time when row zero is reset to commence exposure, t_{0,RS,k}. However, light source LS2 can remain disabled longer, until it is time to start resetting rows in the upper half of the sensor pixel array, t_{ON,ULS,k}=t_{N/2,RS,k}. As already mentioned above, it is preferable to judiciously orient pixel array PA with reference to the location of light source LS1, LS2 on casing 310, so that its readout can take place with this synchronization.

At the end of the batch, when capture concludes and idle time begins, light source LS1 is disabled sooner than the time corresponding to last row (N) being read out. Light source LS1 can be disabled as soon as row N/2 is read out, t_{OFF,LLS,k}=t_{N/2,RD,k+3}. Light source LS2 will remain enabled until the last row is read out, t_{N,RD,k+3}.

The above operations are examples where, while a first group of the pixels is integrating light received from a first one of the sectors, light source LS1 is enabled, but while a second group of the pixels is integrating light received from a second one of the sectors, light source LS1 is disabled. The pixels integrate received light, for generating a charge corresponding to a detected sample. Moreover, light source LS2 can be enabled while the second group of pixels is integrating light received from the second sector.

The operation described above can be modified to include the use of global pixel array reset. In this case, both light sources are enabled simultaneously with the global reset event.

What is true for FIG. 3 and two sectors can be also embodied for N light sources and N respective distinct sectors. N can have any value larger than one, such as two, three, four, eight and so on. An example is now described where N equals four.

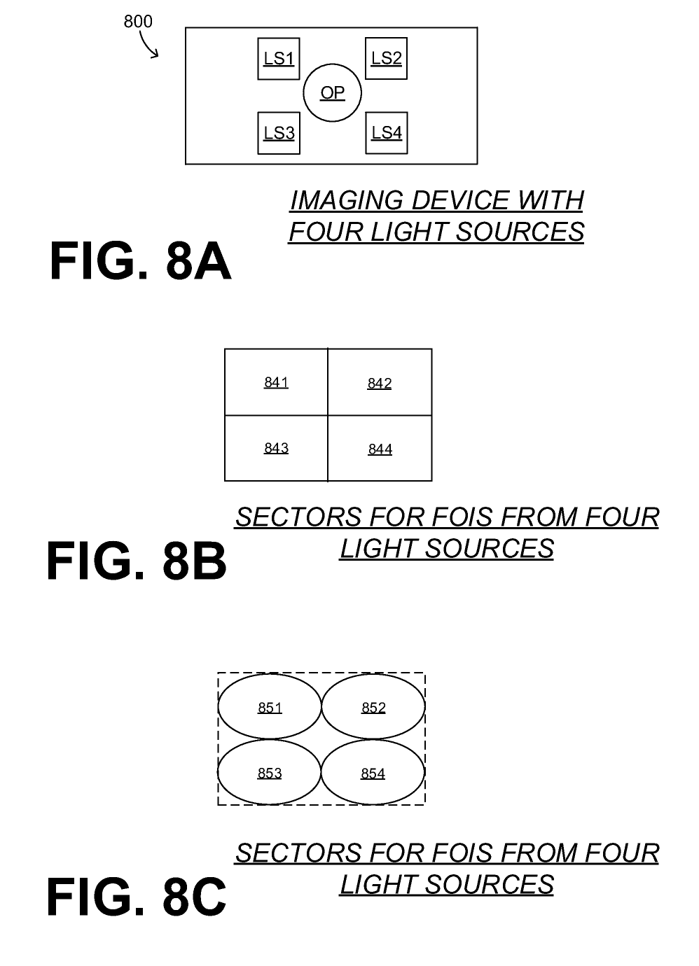

FIG. 8A is a diagram of a front view of an imaging device 800 according to an embodiment. Device 800 has an opening OP, and four light sources LS1, LS2, LS3, LS4.

FIG. 8B is a diagram of a first set of possible sectors for fields of illumination (FOIs) resulting from imaging device 800. The set includes FOIs 841, 842, 843, 844. Of course, the divergence described earlier is understood because FOIs 841, 842, 843, 844 cover an area at least as large as front object FO, which is much larger area than that of imaging device 800.

FIG. 8C is a diagram of a second set of possible sectors for FOIs resulting from imaging device 800. The set includes FOIs 851, 852, 853, 854.

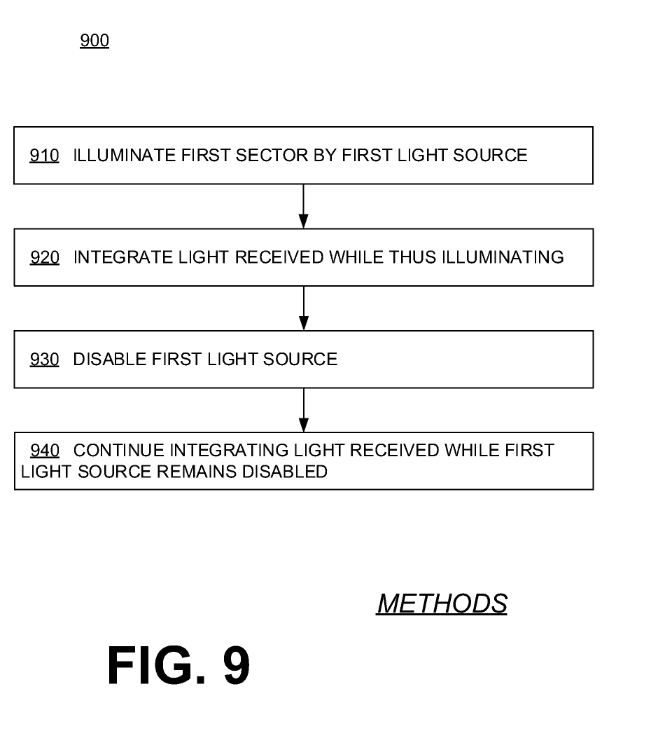

FIG. 9 shows a flowchart 900 for describing a method. The method of flowchart 900 may also be practiced by embodiments described above. The method is for an imaging device that has a casing, a pixel array and a first light source, and defines with respect to the casing a field of view (“FOV”), and can operate in the rolling shutter mode.

According to an operation 910, a first sector of the FOV is illuminated by the first light source. According to a next operation 920, light received in the pixel array is integrated, while there is illuminating by the first light source. According to a next operation 930, the first light source is disabled. According to a next operation 940, light received in the pixel array continues to be integrated.

Additional operations are also possible. For example, if the imaging device also includes a second light source, a second sector of the FOV can be illuminated by the second light source. Light received in the pixel array can continue to be integrated, and then the second light source can be disabled. Still light received in the pixel array can continue to be integrated even after the second light source can be disabled.

In the above, the order of operations is not constrained to what is shown, and different orders may be possible according to different embodiments. In addition, in certain embodiments, new operations may be added, or individual operations may be modified or deleted.

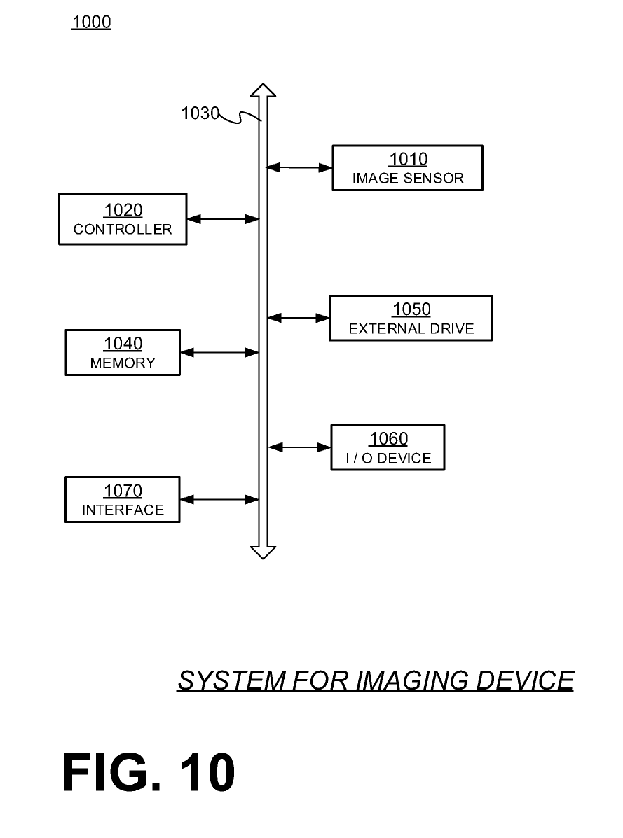

FIG. 10 depicts a controller-based system 1000 for an imaging device that can be made according to embodiments. System 1000 includes an image sensor 1010, which can be made, for example, as pixel array PA. As such, system 1000 could be, without limitation, a computer system, an imaging device such as device 300, a camera system, a scanner, a machine vision system, a vehicle navigation system, a smart telephone, a video telephone, a personal digital assistant (PDA), a mobile computer, a surveillance system, an auto focus system, a star tracker system, a motion detection system, an image stabilization system, a data compression system for high-definition television, and so on.

System 1000 further includes a controller 1020, which could be a CPU, a digital signal processor, a microprocessor, a microcontroller, an application-specific integrated circuit (ASIC), a programmable logic device (PLD), and so on. Controller 1020 can be made, for example, as controller 320.

Returning to FIG. 3 controller 320 may include an array signal generator SGA. Array signal generator SGA can be configured to generate array signals SA with which to control the pixel array PA for various functions, including controlling the pixels to integrate received light. Controller 320 may also include a first signal generator SG1 and a second signal generator SG2. Generators SG1, SG2 may generate first and second signals S1, S2 respectively, with which to control operation of the first and second light sources LS1, LS2 respectively. As such, the controller can perform the operations described above, including, for example, controlling the first light source LS1 by first signals S1 to be enabled for only a portion of the time during which array signals SA control the pixels to integrate received light.

Returning again to FIG. 10, a method then for controller 1020 includes generating array signals SA with which to control the pixels to integrate received light, and generating first signals S1 with which to control an operation of first light source S1 to be enabled for only a portion of the time during which the array signals control the pixels to integrate received light. Additional steps have been described above, for example about also the other light source.

In some embodiments, controller 1020 communicates, over bus 1030, with image sensor 1010. In some embodiments, controller 1020 may be combined with image sensor 1010 in a single integrated circuit. Controller 1020 controls and operates image sensor 1010, by transmitting control signals from output ports, and so on, as will be understood by those skilled in the art.

Controller 1020 may further communicate with other devices in system 1000. One such other device could be a memory 1040, which could be a Random Access Memory (RAM) or a Read Only Memory (ROM). Memory 1040 may be configured to store instructions to be read and executed by controller 1020.

Another such device could be an external drive 1050, which can be a compact disk (CD) drive, a thumb drive, and so on. One more such device could be an input/output (I/O) device 1060 for a user, such as a keypad, a keyboard, and a display. Memory 1040 may be configured to store user data that is accessible to a user via the I/O device 1060.

An additional such device could be an interface 1070. System 1000 may use interface 1070 to transmit data to or receive data from a communication network. The transmission can be via wires, for example via cables, or USB interface. Alternately, the communication network can be wireless, and interface 1070 can be wireless and include, for example, an antenna, a wireless transceiver and so on. The communication interface protocol can be that of a communication system such as CDMA, GSM, NADC, E-TDMA, WCDMA, CDMA2000, Wi-Fi, Muni Wi-Fi, Bluetooth, DECT, Wireless USB, Flash-OFDM, IEEE 802.20, GPRS, iBurst, WiBro, WiMAX, WiMAX-Advanced, UMTS-TDD, HSPA, EVDO, LTE-Advanced, MMDS, and so on.

A person skilled in the art will be able to practice the present invention in view of this description, which is to be taken as a whole. Details have been included to provide a thorough understanding. In other instances, well-known aspects have not been described, in order to not obscure unnecessarily the present invention.

This description includes one or more examples, but that does not limit how the invention may be practiced. Indeed, examples or embodiments of the invention may be practiced according to what is described, or yet differently, and also in conjunction with other present or future technologies.

One or more embodiments described herein may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “computer-readable media” includes computer-storage media. For example, computer-storage media may include, but are not limited to, magnetic storage devices (e.g., hard disk, floppy disk, and magnetic strips), optical disks (e.g., compact disk [CD] and digital versatile disk [DVD]), smart cards, flash memory devices (e.g., thumb drive, stick, key drive, and SD cards), and volatile and nonvolatile memory (e.g., RAM and ROM).

The following claims define certain combinations and subcombinations of elements, features and steps or operations, which are regarded as novel and non-obvious. Additional claims for other such combinations and subcombinations may be presented in this or a related document.

In the claims appended herein, the inventor invokes 35 U.S.C. §112, paragraph 6 only when the words “means for” or “steps for” are used in the claim. If such words are not used in a claim, then the inventor does not intend for the claim to be construed to cover the corresponding structure, material, or acts described herein (and equivalents thereof) in accordance with 35 U.S.C. §112, paragraph 6.

What is claimed is:

1. An imaging device, comprising:
a casing;
a defined field of view (“FOV”); and
a plurality of N light sources on the casing, each having a field of illumination (“FOI”) configured to illuminate a respective one of N distinct sectors of the FOV at a higher intensity than any of the other sectors.

2. The device of claim 1, in which
N equals one of two, three, four and eight.

3. The device of claim 1, in which
a first one of the light sources illuminates a first one of the sectors with more than twice the intensity than any other sector.

4. The device of claim 1, in which
a first one of the light sources illuminates a first one of the sectors with more than five times the intensity than any other sector.

5. The device of claim 1, in which
a certain one of the light sources includes a mirror system to illuminate a respective certain one of the sectors.

6. The device of claim 1, in which
a certain one of the light sources includes a lens system to illuminate a respective certain one of the sectors.

7. The device of claim 1, in which
a certain one of the light sources includes a holographic optical filter to illuminate a respective certain one of the sectors.

8. The device of claim 1, in which
a certain one of the light sources is a specially shaped lamp so as to illuminate a respective certain one of the sectors.

9. The device of claim 1, in which
the light sources emit modulated light when enabled.

10. The device of claim 1, further comprising:
a pixel array within the casing that includes pixels, and in which
while a first group of the pixels is integrating light received from a first one of the sectors, a first one of the first light sources is enabled, but
while a second group of the pixels is integrating light received from a second one of the sectors, the first light source is disabled.

11. The device of claim 10, in which
the pixels integrate received light according to the rolling shutter mode.

12. The device of claim 10, in which
while the second group of pixels is integrating light received from the second sector, a second one of the light sources is enabled.

13. A method for an imaging device that has a casing, a defined field of view (“FOV”), a pixel array and a first light source, the method comprising:
illuminating by the first light source a first sector of the FOV;
integrating light received in the pixel array while thus illuminating by the first light source;
disabling the first light source; and
then continuing to integrate light received in the pixel array while the first light source remains disabled.

14. The method of claim 13, in which
the first light source emits modulated light when enabled.

15. The method of claim 13,
in which the imaging device also has a second light source, and
further comprising:
illuminating by the second light source a second sector of the FOV distinct from the first sector;
integrating light received in the pixel array while thus illuminating by the second light source;
disabling the second light source; and
then continuing to integrate light received in the pixel array while the second light source remains disabled.

16. A controller for an imaging device that includes an array of pixels and a first light source, the controller comprising:
an array signal generator configured to generate array signals; and
a first signal generator configured to generate first signals, and
in which the first signals control the first light source to be enabled for only a portion of the time during which the array signals control the pixels to integrate received light.

17. The controller of claim 16, in which
the first light source emits modulated light when enabled.

18. The controller of claim 16, in which
the controller is formed integrally with the array.

19. The controller of claim 16, in which
the imaging device has a defined a field of view (“FOV”),
the first light source is configured to illuminate a first sector of the FOV, and
the first signals control the first light source to be disabled for at least a portion of the time during which the array signals control the pixel array to integrate light received from a second sector of the FOV distinct from the first sector.

20. The controller of claim 19, in which
the array signals control the pixel array to integrate received light in a rolling shutter mode.

21. The controller of claim 19, in which
the imaging device also includes a second light source, and
further comprising: a second signal generator configured to generate second signals, and
in which the second signals control the second light source to be enabled for only a portion of the time during which the array signals control the pixels to integrate received light.

22. The controller of claim 21, in which
the second light source is configured to illuminate the second sector, and
the second signals control the second light source to be disabled for at least a portion of the time during which the array signals control the pixel array to integrate light received from the first sector.

23. The controller of claim 22, in which
the array signals control the pixel array to integrate received light in a rolling shutter mode.

24. A method for a controller to control an imaging device that includes a pixel array and a first light source, the method comprising:
generating array signals; and
generating first signals, and
in which the first signals control the first light source to be enabled for only a portion of the time during which the array signals control the pixels to integrate received light.

25. The method of claim 24, in which
the first light source emits modulated light when enabled.

26. The method of claim 24, in which
the controller is formed integrally with the array.

27. The method of claim 24, in which
the imaging device has a defined field of view (“FOV”),
the first light source is configured to illuminate a first sector of the FOV, and
the first signals control the first light source to be disabled for at least a portion of the time during which the array signals control the pixel array to integrate light received from a second sector of the FOV distinct from the first sector.

28. The method of claim 27, in which
the array signals control the pixel array to integrate received light in a rolling shutter mode.

29. The method of claim 27, in which
the imaging device also includes a second light source, and
further comprising: generating second signals and
in which the second signals control the second light source to be enabled for only a portion of the time during which the array signals control the pixels to integrate received light.

30. The method of claim 29, in which
the second light source is configured to illuminate the second sector, and
the second signals control the second light source to be disabled for at least a portion of the time during which the array signals control the pixel array to receive light from the first sector.

31. The method of claim 30, in which
the array signals control the pixel array to integrate received light in a rolling shutter mode.
